(19) United States
(12) Patent Application Publication
(10) Pub. No.: US 2012/0162195 A1
(43) Pub. Date: Jun. 28, 2012

(54) IMAGE PROCESSING APPARATUS, COMPUTER-READABLE STORAGE MEDIUM HAVING IMAGE PROCESSING PROGRAM STORED THEREIN, IMAGE PROCESSING METHOD, AND IMAGE PROCESSING SYSTEM

(75) Inventors: Hiroyuki YAMADA, Kyoto (JP); David Broske, Northfield, MN (US)

(73) Assignee: NINTENDO CO., LTD., Kyoto (JP)

(21) Appl. No.: 13/084,883

(22) Filed: Apr. 12, 2011

(30) Foreign Application Priority Data
Dec. 28, 2010 (JP) 2010-293558

(51) Int. Cl. G06T 15/00

(52) U.S. Cl. 345/419

(57) ABSTRACT

An image processing apparatus comprises: virtual camera setting means for setting a left virtual camera and a right virtual camera such that the left virtual camera and the right virtual camera are spaced apart from each other at a predetermined interval for taking an image of a virtual space; stereoscopic viewing image output means for sequentially outputting stereoscopic viewing images each of which is generated on the basis of an image for a left eye obtained by taking an image of the virtual space with the left virtual camera and an image for a right eye obtained by taking an image of the virtual space with the right virtual camera; and stereoscopic viewing image storing means for storing any of the stereoscopic viewing images sequentially outputted by the stereoscopic viewing image output means, on the basis of a predetermined condition.

### CROSS REFERENCE TO RELATED APPLICATION

The disclosure of Japanese Patent Application No. 2010-293558, filed on Dec. 28, 2010, is incorporated herein by reference.

### BACKGROUND OF THE INVENTION

1. Field of the Invention

The present invention relates to an image processing apparatus, a computer-readable storage medium having an image processing program stored therein, an image processing method, and an image processing system. Specifically, the present invention relates to a computer-readable storage medium having an image processing program stored therein, an image processing apparatus, an image processing method, and an image processing system, for storing an image selectively from sequentially outputted stereoscopically visible images.

2. Description of the Background Art

It is known to obtain an image such as a still image by capturing (stilling or taking) an image developed on a screen. For example, Japanese Patent No. 3793201 (hereinafter, referred to as Patent Document 1) discloses a game apparatus that displays a game image including a player character and another virtual object. In the apparatus, a usual image is displayed on one of display sections, and a captured image is displayed on the other of the display sections.

However, in the apparatus disclosed in Patent Document 1, video images that can be captured and images that are displayed are limited to images in each of which an object is displayed two-dimensionally. In other words, such an apparatus as disclosed in Patent Document 1 cannot capture an image sequentially developed on a display device capable of stereoscopic display. Here, a display device capable of stereoscopic display provides a user with a sense of depth in a three dimensional image by using phenomena such as binocular parallax (difference in apparent positions when the same point is looked at by a right eye and a left eye), convergence, and focusing.

### SUMMARY OF THE INVENTION

Therefore, an object of the present invention is to provide a novel image processing apparatus, a novel computer-readable storage medium having an image processing program stored therein, a novel image processing method, and a novel image processing system.

Another object of the present invention is to provide an image processing apparatus, a computer-readable storage medium having an image processing program stored therein, an image processing method, and an image processing system, which can store a rendered stereoscopic viewing image for stereoscopic viewing.

In order to attain the object mentioned above, the present invention can be provided, as an example, in the following aspects. The following specific description is in all aspects illustrative for the understanding of the extent of the present invention, and is not intended to be limited thereto. That is, it is understood that, from the specific description, the one skilled in the art can implement the present invention in the equivalent range based on the description of the present invention and on the common technological knowledge.

In one aspect, the present invention provides an image processing apparatus. The image processing apparatus comprises virtual camera setting means, stereoscopic viewing image output means, and stereoscopic viewing image storing means.

The virtual camera setting means sets a left virtual camera and a right virtual camera such that the left virtual camera and the right virtual camera are spaced apart from each other at a predetermined interval for taking an image of a virtual space. The stereoscopic viewing image output means sequentially outputs stereoscopic viewing images each of which is generated on the basis of an image for a left eye obtained by taking an image of the virtual space with the left virtual camera and an image for a right eye obtained by taking an image of the virtual space with the right virtual camera. The stereoscopic viewing image storing means stores any of the stereoscopic viewing images sequentially outputted by the stereoscopic viewing image output means, on the basis of a predetermined condition.

As used herein, the “stereoscopic viewing image” refers to an image or an image group that has a characteristic of being perceived as a stereoscopically visible image with a sense of depth by an observer in a state where the image is visibly provided (e.g., has a binocular disparity).

In one embodiment, the stereoscopic viewing image storing means may store the stereoscopic viewing image as still image data including the image for the left eye and the image for a right eye.

In one embodiment, the image processing apparatus may further comprise camera interval setting means for setting an interval between the left virtual camera and the right virtual camera on the basis of an input from a user. The camera interval setting means can set the left virtual camera and the right virtual camera on the basis of the interval set by the camera interval setting means. The stereoscopic viewing image output means can sequentially output stereoscopic viewing images on the basis of an image for a left eye and an image for a right eye that are obtained by taking images of the virtual space with the left virtual camera and the right virtual camera on the basis of the set interval. The stereoscopic viewing image storing means can store any of the output stereoscopic viewing images on the basis of a predetermined condition.

In one embodiment, the image processing apparatus may further comprise reproduction means for reproducing later the stereoscopic viewing image stored in the stereoscopic viewing image storing means.

In one embodiment, the image processing apparatus may further comprise reception means for receiving, from a user, an input for adjusting a disparity of the stereoscopic viewing image. The camera interval setting means can set the interval between the left virtual camera and the right virtual camera such that the interval corresponds to a disparity based on the input received by the reception means. The stereoscopic viewing image storing means can store any of the outputted stereoscopic viewing images with the set disparity on the basis of a predetermined condition. When reproducing the stereoscopic viewing image stored as the still image data, the reproduction means can reproduce an image for a left eye and an image for a right eye that are used for forming the stereoscopic viewing image, with the set disparity regardless of the input received by the reception means.

In one embodiment, a predetermined reference point that changes in position or direction in the virtual space may be present in the virtual space, and the left virtual camera and the right virtual camera can be set in accordance with the position and/or the direction of the reference point.

In one embodiment, the reference point may be a player object of which movement is controlled by an input of a user.

In one embodiment, the image processing apparatus may further comprise input means for obtaining input information from a user. The predetermined condition is that predetermined input information is obtained by the input means, and the stereoscopic viewing image storing means stores a stereoscopic viewing image that is outputted by the stereoscopic viewing image output means when the predetermined input information is obtained.

In one embodiment, a plurality of virtual objects including a player object that is controllable by a player may be present in the virtual space. The virtual camera setting means can set the left virtual camera and the right virtual camera such that the left virtual camera and the right virtual camera are located in a position corresponding to a viewpoint of the player object.

In one embodiment, the virtual camera setting means may set the left virtual camera and the right virtual camera such that the left virtual camera and the right virtual camera are located in a position that is reversibly and selectively changed between a position corresponding to a viewpoint of the player object and a position other than the position corresponding to the viewpoint of the player object. The stereoscopic viewing image storing means can store a stereoscopic viewing image that is outputted by the stereoscopic viewing image output means after the left virtual camera and the right virtual camera are set by the virtual camera setting means so as to be located in the position corresponding to the viewpoint of the player object.

In one embodiment, a plurality of virtual objects including a player object that is controllable by a player may be present in the virtual space. The image processing apparatus can further comprise display state determination means for determining a display state of the plurality of virtual objects on the basis of a predetermined parameter. The stereoscopic viewing image storing means can store the predetermined parameter and positions of the left virtual camera and the right virtual camera.

The reproduction means may provide a predetermined image and predetermined information to the reproduced stereoscopic viewing image, and may display the predetermined image and the predetermined information.

In one embodiment, the image processing apparatus can further comprise edit means for editing the reproduced stereoscopic viewing image on the basis of an operation of a user.

In addition, in another aspect, the apparatus described above may be implemented as a computer-readable storage medium having stored therein a program used for implementing the function of the apparatus, or as a system including one or more apparatuses that are communicably connected to each other. In addition, the present invention includes a method that can be implemented in the computer-readable storage medium having stored therein the program, the apparatus, or the system.

As used herein, the term “computer-readable storage medium” indicates any apparatus or medium capable of storing a program, a code, and/or data to be used in a computer system. The computer-readable storage medium may be any one of a volatile device and a nonvolatile device as long as it can be read by a computer system. Examples of computer-readable storage media include a magnetic tape, a hard disc drive (HDD), a compact disc (CD), a digital versatile disc (DVD), a Blu-ray disc (BD), a semiconductor memory, but the present invention is not limited thereto.

As used herein, the term “system” (for example, a game system, or an information processing system) may include one apparatus, or may include a plurality of apparatuses each of which can communicate with another one of the apparatuses.

As used herein, a state where an apparatus or system is “connected” to another apparatus or system is not limited to a state of being connected by a line, and can include a state of being wirelessly connected.

A desired stereoscopic viewing image can be stored from sequentially displayed stereoscopic viewing images on the basis of a predetermined condition.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a game apparatus 10 in an opened state;

FIG. 2 is a left side view, a front view, a right side view, and a rear view of the game apparatus 10 in a closed state;

FIG. 3 is a block diagram showing an internal configuration of the game apparatus 10;

FIG. 4A is a schematic diagram showing a positional relation between virtual objects located in a virtual space;

FIG. 4B is a schematic diagram showing a situation where an image (first person image) obtained when a virtual object OBJ2 present in a line-of-sight direction D2 is observed from the position of a virtual object OBJ1 shown in FIG. 4A is displayed on an upper LCD 22;

FIG. 5 is a schematic diagram showing a memory map of a main memory 32 of the game apparatus 10;

FIG. 6A is a flowchart showing an example of main processing performed on the basis of an image processing program in the game apparatus 10 that is an exemplified embodiment of the present invention;

FIG. 6B is a flowchart showing an example of a screen shot taking process in the flowchart of FIG. 6A; and

FIG. 6C is a flowchart showing an example of a taken image display process.

### DESCRIPTION OF THE PREFERRED EMBODIMENTS

(Structure of Game Apparatus)

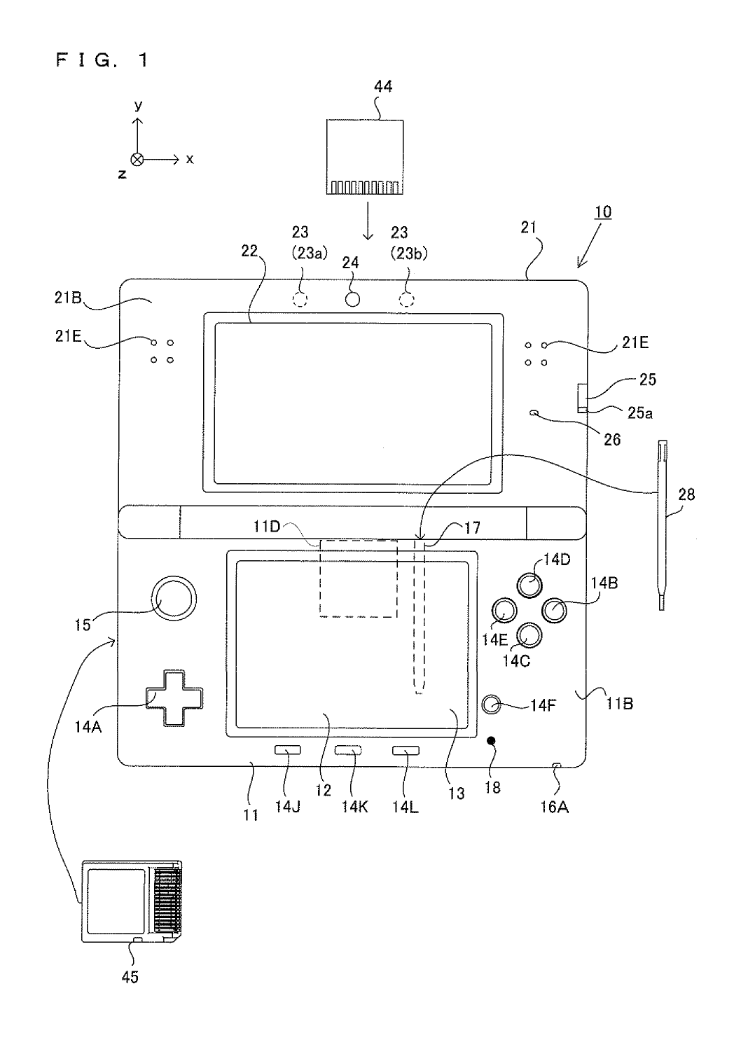

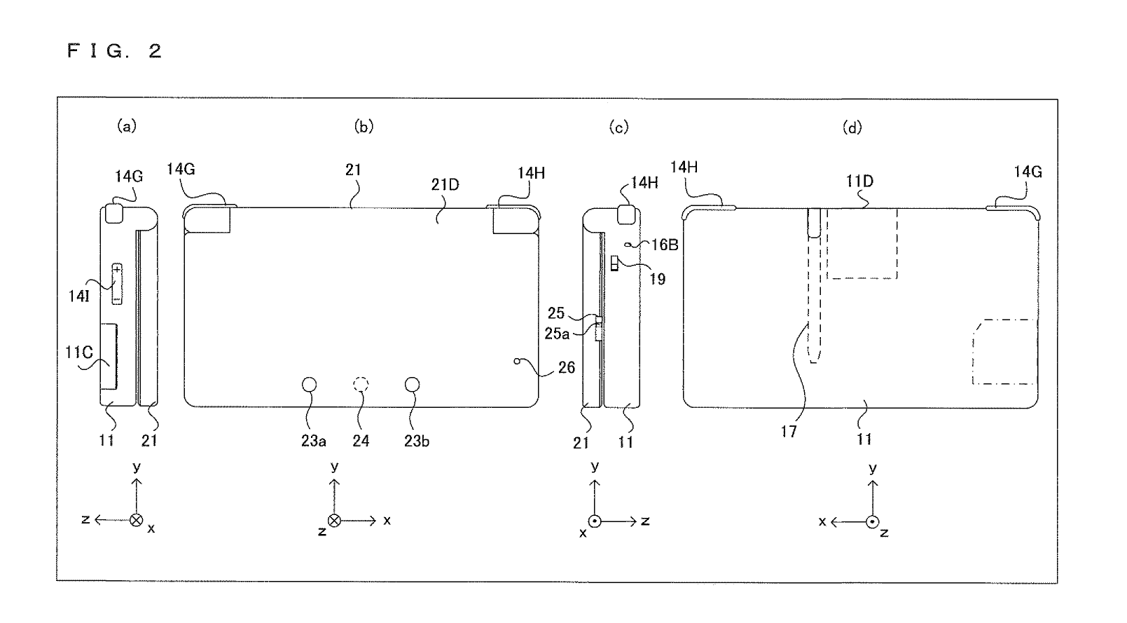

Hereinafter, a game apparatus according to one embodiment of the present invention will be described. FIGS. 1 and 2 are each a plan view of an outer appearance of a game apparatus 10. The game apparatus 10 is a hand-held game apparatus, and is configured to be foldable as shown in FIGS. 1 and 2. FIG. 1 shows the game apparatus 10 in an opened state, and FIG. 2 shows the game apparatus 10 in a closed state. FIG. 1 is a front view of the game apparatus 10 in the opened state. The game apparatus 10 is able to take an image by means of an imaging section, display the taken image on a screen, and store data of the taken image. The game apparatus 10 can execute a game program which is stored in an exchangeable memory card or a game program which is received from a server or another game apparatus, and can display, on the screen, an image generated by computer graphics processing, such as an image taken by a virtual camera set in a virtual space, for example.

Initially, an external structure of the game apparatus 10 will be described with reference to FIGS. 1 and 2. The game apparatus 10 includes a lower housing 11 and an upper housing 21 as shown in FIGS. 1 and 2. The lower housing 11 and the upper housing 21 are connected to each other so as to be openable and closable (foldable).

(Description of Lower Housing)

Initially, a structure of the lower housing 11 will be described. As shown in FIGS. 1 and 2, in the lower housing 11, a lower LCD (Liquid Crystal Display) 12, a touch panel 13, operation buttons 14A to 14L, an analog stick 15, an LED 16A and an LED 16B, an insertion opening 17, and a microphone hole 18 are provided. Hereinafter, these components will be described in detail.

As shown in FIG. 1, the lower LCD 12 is accommodated in the lower housing 11. The number of pixels of the lower LCD 12 may be, for example, 320 dots×240 dots (the longitudinal line×the vertical line). The lower LCD 12 is a display device for displaying an image in a planar manner (not in a stereoscopically visible manner), which is different from the upper LCD 22 as described below. Although an LCD is used as a display device in the present embodiment, any other display device such as a display device using an EL (Electro Luminescence), or the like may be used. In addition, a display device having any resolution may be used as the lower LCD 12.

As shown in FIG. 1, the game apparatus 10 includes the touch panel 13 as an input device. The touch panel 13 is mounted on the screen of the lower LCD 12. In the present embodiment, the touch panel 13 may be, but is not limited to, a resistive film type touch panel. A touch panel of any type such as electrostatic capacitance type may be used. In the present embodiment, the touch panel 13 has the same resolution (detection accuracy) as that of the lower LCD 12. However, the resolution of the touch panel 13 and the resolution of the lower LCD 12 may not necessarily be the same. Further, the insertion opening 17 (indicated by dashed line in FIGS. 1 and 2(d)) is provided on the upper side surface of the lower housing 11. The insertion opening 17 is used for accommodating a touch pen 28 which is used for performing an operation on the touch panel 13. Although an input on the touch panel 13 is usually made by using the touch pen 28, a finger of a user may be used for making an input on the touch panel 13, in addition to the touch pen 28.

The operation buttons 14A to 14L are each an input device for making a predetermined input. As shown in FIG. 1, among operation buttons 14A to 14L, a cross button 14A (a direction input button 14A), a button 14B, a button 14C, a button 14D, a button 14E, a power button 14F, a selection button 14J, a HOME button 14K, and a start button 14L are provided on the inner side surface (main surface) of the lower housing 11. The cross button 14A is cross-shaped, and includes buttons for indicating an upward, a downward, a leftward, or a rightward direction. The button 14A to 14E, the selection button 14J, the HOME button 14K, and the start button 14L are assigned functions, respectively, in accordance with a program executed by the game apparatus 10, as necessary. For example, the cross button 14A is used for selection operation and the like, and the operation buttons 14B to 14E are used for, for example, determination operation and cancellation operation. The power button 14F is used for powering the game apparatus 10 on/off.

The analog stick 15 is a device for indicating a direction. The analog stick 15 has a top, corresponding to a key, which slides parallel to the inner side surface of the lower housing 11. The analog stick 15 acts in accordance with a program executed by the game apparatus 10. For example, when a game in which a predetermined virtual object appears in a three-dimensional virtual space is executed by the game apparatus 10, the analog stick 15 acts as an input device for moving the predetermined virtual object in the three-dimensional virtual space. In this case, the predetermined virtual object is moved in a direction in which the top corresponding to the key of the analog stick 15 slides. As the analog stick 15, a component which enables an analog input by being tilted by a predetermined amount, in any direction, such as the upward, the downward, the rightward, the leftward, or the diagonal direction, may be used.

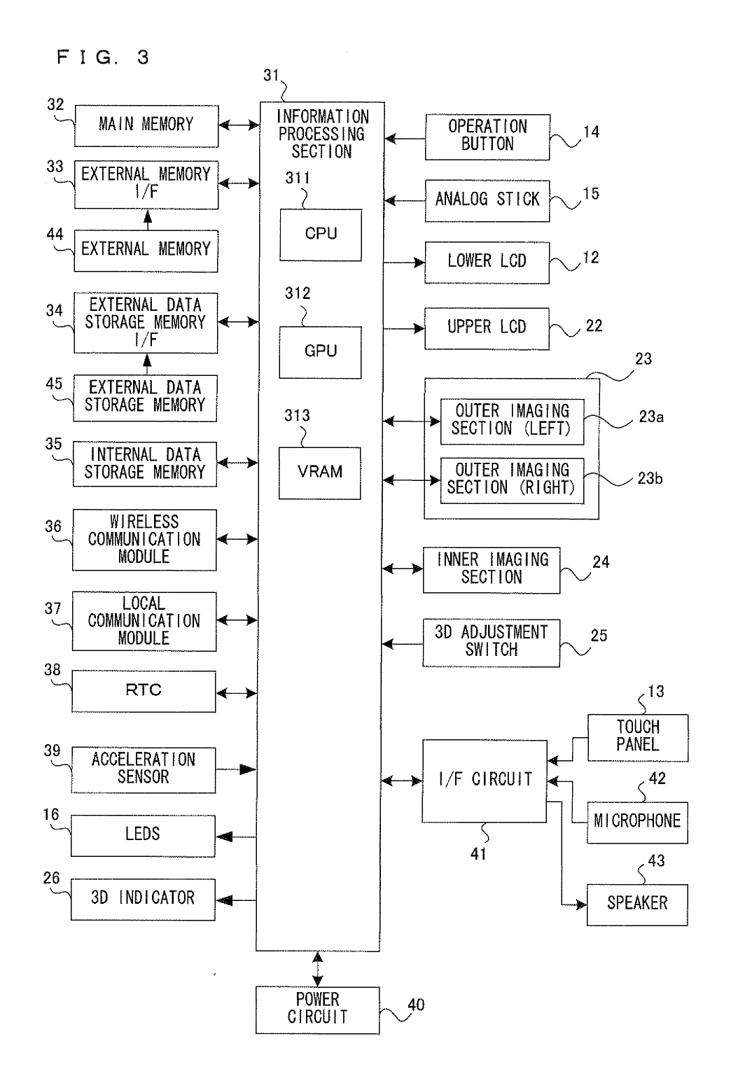

Further, the microphone hole 18 is provided on the inner side surface of the lower housing 11. Under the microphone hole 18, a microphone 42 (see FIG. 3) is provided as a sound input device described below, and the microphone 42 detects for a sound from the outside of the game apparatus 10.

FIG. 2(a) is a left side view of the game apparatus 10 in the closed state. FIG. 2(b) is a front view of the game apparatus 10 in the closed state. FIG. 2(c) is a right side view of the game apparatus 10 in the closed state. FIG. 2(d) is a rear view of the game apparatus 10 in the closed state. As shown in FIGS. 2(b) and 2(d), an L button 14G and an R button 14H are provided on the upper side surface of the lower housing 11. The L button 14G and the R button 14H act, for example, as shutter buttons (imaging instruction buttons) of the imaging section. Further, as shown in FIG. 2(a), a sound volume button 14I is provided on the left side surface of the lower housing 11. The sound volume button 14I is used for adjusting a sound volume of a speaker of the game apparatus 10.

As shown in FIG. 2(a), a cover section 11C is provided on the left side surface of the lower housing 11 so as to be openable and closable. Inside the cover section 11C, a connector (not shown) is provided for electrically connecting between the game apparatus 10 and an external data storage memory 45. The external data storage memory 45 is detachably connected to the connector. The external data storage memory 45 is used for, for example, recording (storing) data of an image taken by the game apparatus 10.

Further, as shown in FIG. 2(d), an insertion opening 11D through which an external memory 44 having a game program stored therein is inserted is provided on the upper side surface of the lower housing 11. A connector (not shown) for electrically connecting between the game apparatus 10 and the external memory 44 in a detachable manner is provided inside the insertion opening 11D. A predetermined game program is executed by connecting the external memory 44 to the game apparatus 10.

Further, as shown in FIGS. 1 and 2(c), a first LED 16A for notifying a user of an ON/OFF state of a power supply of the game apparatus 10 is provided on the lower side surface of the lower housing 11, and a second LED 16B for notifying a user of an establishment state of a wireless communication of the game apparatus 10 is provided on the right side surface of the lower housing 11. The game apparatus 10 can make wireless communication with other devices, and the second LED 16B is lit up when the wireless communication is established. The game apparatus 10 has a function of connecting to a wireless LAN in a method based on, for example, IEEE802.11b/g standard. A wireless switch 19 for enabling/disabling the function of the wireless communication is provided on the right side surface of the lower housing 11 (see FIG. 2(c)).

A rechargeable battery (not shown) acting as a power supply for the game apparatus 10 is accommodated in the lower housing 11, and the battery can be charged through a terminal provided on a side surface (for example, the upper side surface) of the lower housing 11.

(Description of Upper Housing)

Next, a structure of the upper housing 21 will be described. As shown in FIGS. 1 and 2, in the upper housing 21, an upper LCD (Liquid Crystal Display) 22, an outer imaging section 23 (an outer imaging section (left) 23a and an outer imaging section (right) 23b), an inner imaging section 24, a 3D adjustment switch 25, and a 3D indicator 26 are provided. Hereinafter, theses components will be described in detail.

As shown in FIG. 1, the upper LCD 22 is accommodated in the upper housing 21. The number of pixels of the upper LCD 22 may be, for example, 800 dots×240 dots (the horizontal line×the vertical line). Although, in the present embodiment, the upper LCD 22 is an LCD, a display device using an EL (Electro Luminescence), or the like may be used. In addition, a display device having any resolution may be used as the upper LCD 22.

The upper LCD 22 is a display device capable of displaying a stereoscopically visible image. Further, in the present embodiment, an image for a left eye and an image for a right eye are displayed by using substantially the same display area. Specifically, the upper LCD 22 may be a display device using a method in which the image for a left eye and the image for a right eye are alternately displayed in the horizontal direction in predetermined units (for example, every other line). Alternatively, a display device using a method in which the image for a left eye and the image for a right eye are alternately displayed for a predetermined time period may be used. Further, in the present embodiment, the upper LCD 22 is a display device capable of displaying an image which is stereoscopically visible with naked eyes. A lenticular lens type display device or a parallax barrier type display device is used which enables the image for a left eye and the image for a right eye, which are alternately displayed in the horizontal direction, to be separately viewed by the left eye and the right eye, respectively. In the present embodiment, the upper LCD 22 of a parallax barrier type is used. The upper LCD 22 displays, by using the image for a right eye and the image for a left eye, an image (a stereoscopic image) which is stereoscopically visible with naked eyes. That is, the upper LCD 22 allows a user to view the image for a left eye with her/his left eye, and the image for a right eye with her/his right eye by utilizing a parallax barrier, so that a stereoscopic image (a stereoscopically visible image) exerting a stereoscopic effect for a user can be displayed. Further, the upper LCD 22 may disable the parallax barrier. When the parallax barrier is disabled, an image can be displayed in a planar manner (it is possible to display a planar visible image which is different from a stereoscopically visible image as described above. Specifically, a display mode is used in which the same displayed image is viewed with a left eye and a right eye.). Thus, the upper LCD 22 is a display device capable of switching between a stereoscopic display mode for displaying a stereoscopically visible image and a planar display mode (for displaying a planar visible image) for displaying an image in a planar manner. The switching of the display mode is performed by the 3D adjustment switch 25 described below.

The outer imaging section 23 is a generic term used to include two imaging sections 23a and 23b provided on the outer side surface 21D, which is a surface of the upper housing 21 that is opposite to the main surface having the upper LCD 22 mounted thereon. The imaging directions of the outer imaging section (left) 23a and the outer imaging section (right) 23b are each the same as the outward normal direction of the outer side surface 21D. The outer imaging section (left) 23a and the outer imaging section (right) 23b can be used as a stereo camera depending on a program executed by the game apparatus 10. Each of the outer imaging section (left) 23a and the outer imaging section (right) 23b includes an imaging device, such as a CCD image sensor or a CMOS image sensor, having a common predetermined resolution, and a lens. The lens may have a zooming mechanism.

The inner imaging section 24 is positioned on the inner side surface (main surface) 21B of the upper housing 21, and acts as an imaging section which has an imaging direction which is the same direction as the inward normal direction of the inner side surface. The inner imaging section 24 includes an imaging device, such as a CCD image sensor and a CMOS image sensor, having a predetermined resolution, and a lens. The lens may have a zooming mechanism.

The 3D adjustment switch 25 is a slide switch, and is used for switching a display mode of the upper LCD 22 as described above. Further, the 3D adjustment switch 25 is used for adjusting the stereoscopic effect of a stereoscopically visible image (stereoscopic image) which is displayed on the upper LCD 22. A slider 25a of the 3D adjustment switch 25 is slidable to any position in a predetermined direction (along the longitudinal direction of the right side surface), and a display mode of the upper LCD 22 is determined in accordance with the position of the slider 25a. In addition, a manner in which the stereoscopic image is visible is adjusted in accordance with the position of the slider 25a.

The 3D indicator 26 indicates whether or not the upper LCD 22 is in the stereoscopic display mode. The 3D indicator 26 is implemented as a LED, and is lit up when the stereoscopic display mode of the upper LCD 22 is enabled. The 3D indicator 26 may be lit up only when the program processing for displaying a stereoscopic viewing image is performed in a state where the upper LCD 22 is in the stereoscopic display mode.

Further, a speaker hole 21E is provided on the inner side surface of the upper housing 21. A sound is outputted through the speaker hole 21E from a speaker 43 described below.

(Internal Configuration of Game Apparatus 10)

Next, an internal electrical configuration of the game apparatus 10 will be described with reference to FIG. 3. FIG. 3 is a block diagram illustrating an internal configuration of the game apparatus 10. As shown in FIG. 3, the game apparatus 10 includes, in addition to the components described above, electronic components such as an information processing section 31, a main memory 32, an external memory interface (external memory I/F) 33, an external data storage memory I/F 34, an internal data storage memory 35, a wireless communication module 36, a local, communication module 37, a real-time clock (RTC) 38, an acceleration sensor 39, a power supply circuit 40, an interface circuit (I/F circuit) 41, and the like. These electronic components are mounted on an electronic circuit substrate, and accommodated in the lower housing 11 (or the upper housing 21).

The information processing section 31 is information processing means which includes a CPU (Central Processing Unit) 311 for executing a predetermined program, a GPU (Graphics Processing Unit) 312 for performing image processing, and the like. The CPU 311 of the information processing section 31 executes a program stored in a memory (for example, the external memory 44 connected to the external memory I/F 33 or the internal data storage memory 35) inside the game apparatus 10, thereby executing processing corresponding to the program. The program executed by the CPU 311 of the information processing section 31 may be acquired from another device through communication with the other device. The information processing section 31 further includes a VRAM (Video RAM) 313. The GPU 312 of the information processing section 31 generates an image in accordance with an instruction from the CPU 311 of the information processing section 31, and renders the image in the VRAM 313. The GPU 312 of the information processing section 31 outputs the image rendered in the VRAM 313, to the upper LCD 22 and/or the lower LCD 12, and the image is displayed on the upper LCD 22 and/or the lower LCD 12.

The main memory 32, the external memory I/F 33, the external data storage memory I/F 34, and the internal data storage memory 35 are connected to the information processing section 31. The external memory I/F 33 is an interface for detachably connecting to the external memory 44. The external data storage memory I/F 34 is an interface for detachably connecting to the external data storage memory 45.

The main memory 32 is volatile storage means used as a work area and a buffer area for (the CPU 311 of) the information processing section 31. That is, the main memory 32 temporarily stores various types of data used for the processing based on the above program, and temporarily stores a program acquired from the outside (the external memory 44, another device, or the like), for example. In the present embodiment, for example, a PSRAM (Pseudo-SRAM) is used as the main memory 32.

The external memory 44 is nonvolatile storage means for storing a program executed by the information processing section 31. The external memory 44 is implemented as, for example, a read-only semiconductor memory. When the external memory 44 is connected to the external memory I/F 33, the information processing section 31 can load a program stored in the external memory 44. A predetermined process is performed by the program loaded by the information processing section 31 being executed. The external data storage memory 45 is implemented as a non-volatile readable and writable memory (for example, a NAND flash memory), and is used for storing predetermined data. For example, images taken by the outer imaging section 23 and/or images taken by another device are stored in the external data storage memory 45. When the external data storage memory 45 is connected to the external data storage memory I/F 34, the information processing section 31 loads an image stored in the external data storage memory 45, and the image can be displayed on the upper LCD 22 and/or the lower LCD 12.

The internal data storage memory 35 is implemented as a non-volatile readable and writable memory (for example, a NAND flash memory), and is used for storing predetermined data. For example, data and/or programs downloaded through the wireless communication module 36 by wireless communication is stored in the internal data storage memory 35.

The wireless communication module 36 has a function of connecting to a wireless LAN by using a method based on, for example, IEEE 802.11.b/g standard. The local communication module 37 has a function of performing wireless communication with the same type of game apparatus in a predetermined communication method (for example, communication based on a unique protocol, or infrared communication). The wireless communication module 36 and the local communication module 37 are connected to the information processing section 31. The information processing section 31 can perform data transmission to and data reception from another device via the Internet by using the wireless communication module 36, and can perform data transmission to and data reception from the same type of another game apparatus by using the local communication module 37.

The acceleration sensor 39 is connected to the information processing section 31. The acceleration sensor 39 detects magnitudes of accelerations (linear accelerations) in the directions of the straight lines along the three axial (xyz axial) directions, respectively. The acceleration sensor 39 is provided inside the lower housing 11. In the acceleration sensor 39, as shown in FIG. 1, the long side direction of the lower housing 11 is defined as x axial direction, the short side direction of the lower housing 11 is defined as y axial direction, and the direction orthogonal to the inner side surface (main surface) of the lower housing 11 is defined as z axial direction, thereby detecting magnitudes of the linear accelerations for the respective axes. The acceleration sensor 39 is, for example, an electrostatic capacitance type acceleration sensor. However, another type of acceleration sensor may be used. The acceleration sensor 39 may be an acceleration sensor for detecting a magnitude of an acceleration for one axial direction or two-axial directions. The information processing section 31 can receive data (acceleration data) representing accelerations detected by the acceleration sensor 39, and detect an orientation and a motion of the game apparatus 10.

The RTC 38 and the power supply circuit 40 are connected to the information processing section 31. The RTC 38 counts time, and outputs the time to the infatuation processing section 31. The information processing section 31 calculates a current time (date) based on the time counted by the RTC 38. The power supply circuit 40 controls power from the power supply (the rechargeable battery accommodated in the lower housing 11 as described above) of the game apparatus 10, and supplies power to each component of the game apparatus 10.

The I/F circuit 41 is connected to the information processing section 31. The microphone 42 and the speaker 43 are connected to the I/F circuit 41. Specifically, the speaker 43 is connected to the I/F circuit 41 through an amplifier which is not shown. The microphone 42 detects a voice from a user, and outputs a sound signal to the I/F circuit 41. The amplifier amplifies a sound signal outputted from the I/F circuit 41, and a sound is outputted from the speaker 43. The touch panel 13 is connected to the I/F circuit 41. The I/F circuit 41 includes a sound control circuit for controlling the microphone 42 and the speaker 43 (amplifier), and a touch panel control circuit for controlling the touch panel. The sound control circuit performs A/D conversion and D/A conversion on the sound signal, and converts the sound signal to a predetermined form of sound data, for example. The touch panel control circuit generates a predetermined form of touch position data based on a signal outputted from the touch panel 13, and outputs the touch position data to the information processing section 31. The touch position data represents a coordinate of a position, on an input surface of the touch panel 13, on which an input is made. The touch panel control circuit reads a signal outputted from the touch panel 13, and generates the touch position data every predetermined time. The information processing section 31 acquires the touch position data, to recognize a position on which an input is made on the touch panel 13.

The operation button 14 includes the operation buttons 14A to 14L described above, and is connected to the information processing section 31. Operation data representing an input state of each of the operation buttons 14A to 14I is outputted from the operation button 14 to the information processing section 31, and the input state indicates whether or not each of the operation buttons 14A to 14I has been pressed. The information processing section 31 acquires the operation data from the operation button 14 to perform processing in accordance with the input on the operation button 14.

The lower LCD 12 and the upper LCD 22 are connected to the information processing section 31. The lower LCD 12 and the upper LCD 22 each display an image in accordance with an instruction from (the GPU 312 of) the information processing section 31. In the present embodiment, the information processing section 31 causes the upper LCD 12 to display a stereoscopic image (stereoscopically visible image).

Specifically, the information processing section 31 is connected to an LCD controller (not shown) of the upper LCD 22, and causes the LCD controller to set the parallax barrier to ON or OFF. When the parallax barrier is set to ON in the upper LCD 22, an image for a right eye and an image for a left eye which are stored in the VRAM 313 of the information processing section 31 are outputted to the upper LCD 22.

More specifically, the LCD controller alternately repeats reading of pixel data of the image for a right eye for one line in the vertical direction, and reading of pixel data of the image for a left eye for one line in the vertical direction, thereby reading, from the VRAM 313, the image for a right eye and the image for a left eye. Thus, an image to be displayed is divided into the images for a right eye and the images for a left eye each of which is a rectangle-shaped image having one line of pixels aligned in the vertical direction, and an image, in which the rectangle-shaped image for the left eye which is obtained through the division, and the rectangle-shaped image for the right eye which is obtained through the division are alternately aligned, is displayed on the screen of the upper LCD 22. A user views the images through the parallax barrier in the upper LCD 22, so that the image for the right eye is viewed by the user's right eye, and the image for the left eye is viewed by the user's left eye. Thus, the stereoscopically visible image is displayed on the screen of the upper LCD 22.

The outer imaging section 23 and the inner imaging section 24 are connected to the information processing section 31. The outer imaging section 23 and the inner imaging section 24 each take an image in accordance with an instruction from the information processing section 31, and output data of the taken image to the information processing section 31.

The 3D adjustment switch 25 is connected to the information processing section 31. The 3D adjustment switch 25 transmits, to the information processing section 31, an electrical signal in accordance with the position of the slider 25a.

The 3D indicator 26 is connected to the information processing section 31. The information processing section 31 controls whether or not the 3D indicator 26 is to be lit up. For example, the information processing section 31 lights up the 3D indicator 26 when the upper LCD 22 is in the stereoscopic display mode. Description thus far is for the internal configuration of the game apparatus 10.

(Exemplified Embodiment of Image Processing Apparatus)

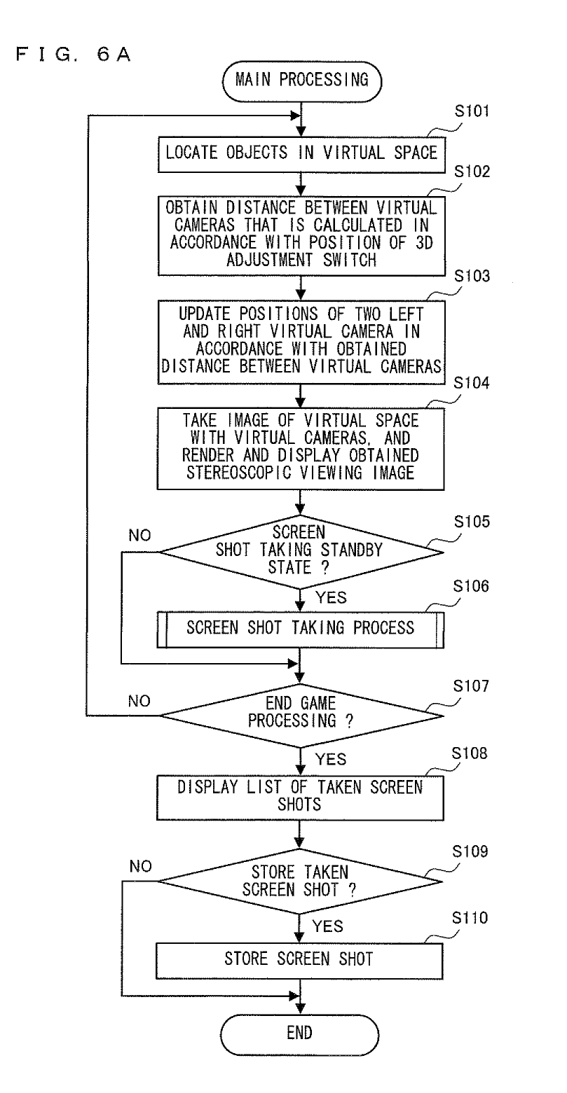

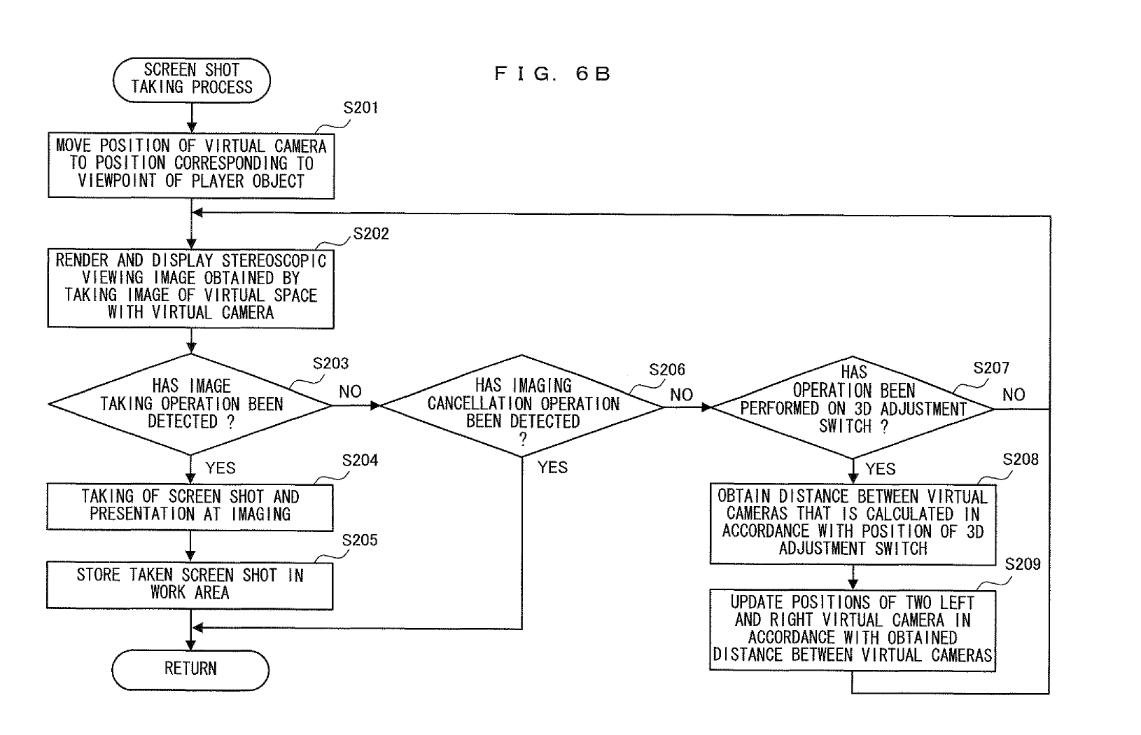

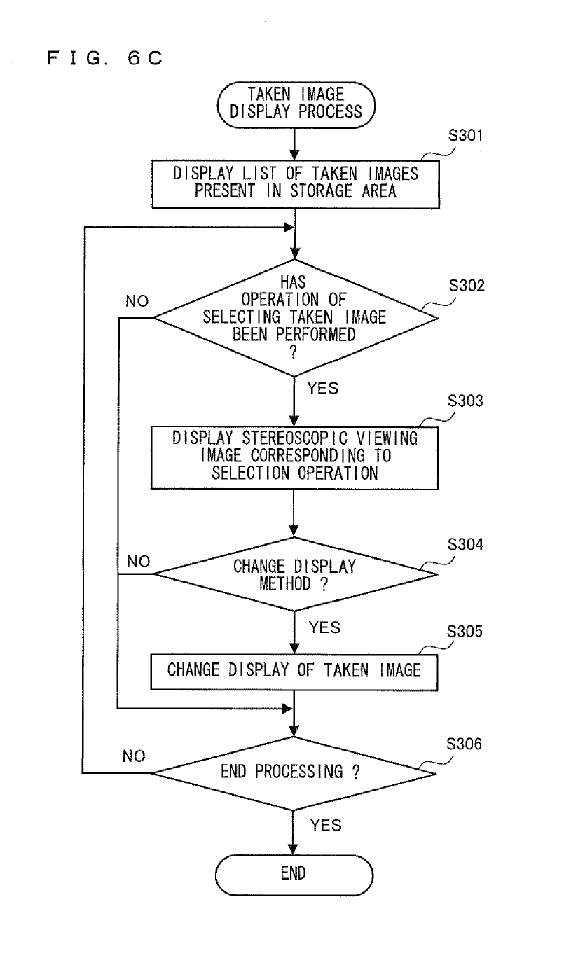

Next, the case will be described in which processing is performed in accordance with an image processing program 70 in the game apparatus 10 that is an image processing apparatus of an exemplified embodiment of the present invention. In addition, in the present embodiment, the CPU 311 performs processes described below (particularly, processes at all steps in flowcharts in FIG. 6A and the subsequent drawings). However, a processor or a dedicated circuit other than the CPU 311 may perform such processes.

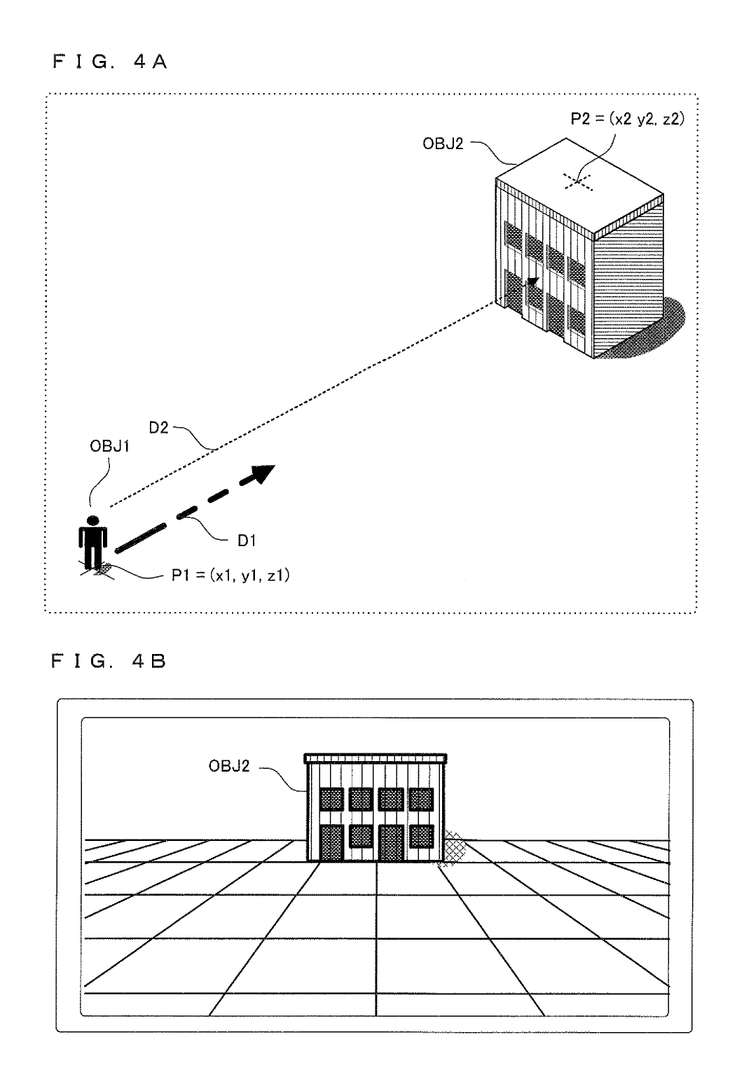

An outline of a control process for an image to be stereoscopically displayed on the upper LCD 22 of the game apparatus 10 will be described with reference to FIG. 4A and the subsequent drawing.

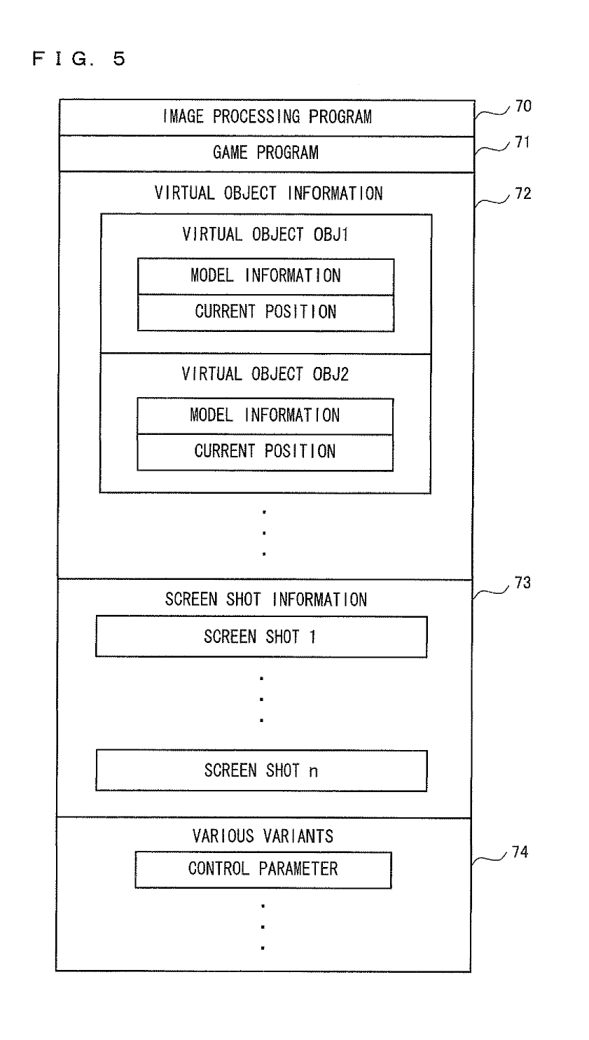

In the exemplified embodiment, the present invention provides the game apparatus 10 as an example of an image processing apparatus that can output a virtual space such that the virtual space is stereoscopically visible. The game apparatus 10 implements exemplified image processing of the present invention by executing the image processing program 70 (a description regarding “memory map” described later; see FIG. 5). The image processing program 70 is called while game processing based on a game program 71 is performed, or is executed as a program for a part of the functions of the game program 71, thereby implementing the image processing of the exemplified embodiment of the present invention. The division of functions between the image processing program 70 and the game program 71 can be optionally changed. Thus, hereinafter, for the convenience sake, a group of programs for the game processing and the image processing that are performed in the game apparatus 10 is referred to representatively as image processing program 70.

The game apparatus 10 provides a player with an image resulting from rendering of a series of virtual spaces, while the game processing is performed. Here, an example of a procedure where the game apparatus 10 renders an image of a virtual space and displays the image will be described with reference to FIG. 4A.

FIG. 4A is a schematic diagram showing a positional relation between virtual objects located in a virtual space. Here, the case will be described in which two virtual objects (indicated by OBJ1 and OBJ2) are located in a virtual space. The virtual object OBJ1 is a virtual object (player object) that is controllable by a player (user) of the game apparatus 10. The virtual object OBJ2 is a virtual object (non-player object) that is not controlled by the player.

While the game apparatus 10 provides the game processing, coordinates (world coordinates) of the positions of the virtual object OBJ1 and the virtual object OBJ2 in the virtual space are provided as three-dimensional coordinates P1 (x1, y1, z1) and P2 (x2, y2, z2), respectively. Then, in accordance with the positions, the CPU 311 locates three-dimensional models (a polygon model representing a person and a polygon model representing a building) defined for the virtual objects OBJ1 and OBJ2, respectively.

In addition, an arrow D1 indicates a moving direction of the exemplified player object OBJ1 in the virtual space. An arrow D2 indicates a line-of-sight direction of the exemplified player object OBJ1 in the virtual space. Note that the direction of the arrow D1 and the direction of the arrow D2 do not necessarily need to be parallel to each other.

The player of the game apparatus 10 moves in the virtual space by controlling the virtual object OBJ1 through an input device (e.g., each of the operation buttons 14A to 14L) of the game apparatus 10 along with a progress of the game processing. In this case, the game apparatus 10 performs transformation of information based on a world coordinate system in which virtual objects are located, into a coordinate system based on a specific viewpoint in the virtual space (a perspective transformation process), and sequentially displays an event progressing in the virtual space, to the user through a display area (e.g., the upper LCD 22) of the game apparatus 10.

Moreover, while the game processing of the present embodiment is performed, the position of a viewpoint (virtual camera) from which the virtual space is looked at can be reversibly changed in accordance with a predetermined setting and an input operation performed by the user on the input device (e.g., an operation performed on the L button 14G and/or the R button 14H). For example, the game apparatus 10 can reversibly change the position of a viewpoint used when the perspective transformation process is actually performed, between a viewpoint based on the position of a player object (the virtual object OBJ1 in the present embodiment) in the virtual space (particularly, a viewpoint of the virtual object OBJ1 that is obtained by taking into consideration the size and shape of the model, for the virtual object OBJ1, which is located at the position; hereinafter, referred to as “first person viewpoint”) and a viewpoint other than the first person viewpoint (hereinafter, referred to as “third person viewpoint”).

Setting and changing of the viewpoint performed between the first person viewpoint and the third person viewpoint will be described with reference to FIGS. 4A and 4B. FIG. 4B is a schematic diagram showing a situation where an image (first person image) obtained when the virtual object OBJ2 present in the line-of-sight direction D2 is observed from the position of the virtual object OBJ1 shown in FIG. 4A is displayed on the upper LCD 22.

In the exemplified embodiment, in a normal state in the progress of the game processing, the game apparatus 10 uses the third person viewpoint and displays, to the user, an image corresponding to an event occurring in the virtual space. For example, in the case of the positional relation as in the example shown in FIG. 4, the game apparatus 10 preferably uses a viewpoint that allows a virtual space including the virtual object OBJ1 to be displayed on the upper LCD 22 (that the user can view). When the player of the game apparatus 10 performs an operation such that the virtual object OBJ1 moves in the direction D1, the CPU 311 preferably performs the perspective transformation process on the basis of a viewpoint from which the virtual space can be overlooked such that the virtual object OBJ2 present in the moving direction D1 can be seen. Next, the CPU 311 displays the resultant image on the upper LCD 22.

As described above, when sequentially displaying, to the user, images representing an event progressing in the virtual space, the game apparatus 10 can provide the player with the sequentially outputted images through the upper LCD 22 such that these images are stereoscopically visible. Specifically, the game apparatus 10 can separately provide images that are perceived by the right and left eyes of the player. More specifically, it suffices that two viewpoints used when a virtual space in which virtual objects are located as described above is subjected to the perspective transformation process are set in order to generate an image to be perceived by a right eye (an image for a right eye) and an image to be perceived by a left eye (an image for a left eye), and the perspective transformation process is performed on the same virtual space (and the virtual objects included therein) on the basis of the two viewpoints.

The two viewpoints that are set thus (a right virtual camera and a left virtual camera) are located so as to be spaced apart from each other by a distance corresponding to the eyes' horizontal separation derived difference (binocular disparity) that is caused between the right eye and the left eye of an observer when the observer views a three-dimensional object. The game apparatus 10 performs the perspective transformation process on the basis of the positions of the right virtual camera and the left virtual camera that are set thus, thereby providing an image for a right eye and an image for a left eye. The image for a right eye and the left eye for a image that are generated thus are displayed on the upper LCD 22 of the game apparatus 10 that uses a parallax barrier method, thereby functioning as a stereoscopic viewing image (an image group that can provide the user with a stereoscopic sense, by causing the image for a left eye and the image for a right eye to be viewed by the left eye and the right eye of the user, respectively).

When the game apparatus 10 sequentially displays images representing an event progressing in the virtual space, to the player such that these images are stereoscopically visible, the player can adjust the set distance between the right virtual camera and the left virtual camera by sliding the slider 25a of the 3D adjustment switch 25. Specifically, by causing a mechanical movement amount (position) of the slider 25a to correspond to the distance between the virtual cameras, the game apparatus 10 can provide the player with an intuitive adjustment of the distance. With regard to a stereoscopically visible image based on the changed distance, the angle of convergence of an object extracted from this image (in the brain of a player that has perceived this image) is changed, and thus the sense of perspective of the object after the change is changed. The change of the distance between the virtual cameras that corresponds to the movement amount of the slider 25a of the 3D adjustment switch 25 can be reflected substantially in real time in the form of stereoscopic viewing of an image that is displayed by the game apparatus 10 to the user and represents an event progressing in the virtual space.

In the exemplified embodiment of the present invention, the game apparatus 10 temporarily stores an image (screen shot) at a certain moment corresponding to an input operation of the player, in a work area of the main memory 32 from stereoscopically visible images provided sequentially through the upper LCD 22, and can store the screen shot in a nonvolatile storage area (e.g., the nonvolatile internal data storage memory 35 or external data storage memory) according to need.

In the present embodiment, at the time point when the above input operation is performed by the player, the game apparatus 10 temporarily stores, in the work area of the main memory 32, still image data including an image for a left eye and an image for a right eye that are taken with the left virtual camera and the right virtual camera that are spaced apart from each other by the distance at the time point. Then, in accordance with an operation of the user, the game apparatus 10 stores the still image data in the internal/external data storage memory. The game apparatus 10 reads the stored still image data later, thereby reproducing, on the upper LCD 22, a stereoscopically visible image (screen shot) in which a desired inter-virtual camera distance (corresponding to a binocular disparity) that is set by the player adjusting the 3D adjustment switch 25 when the screen shot is taken is reflected.

Here, still image data can be provided in any digital image format. Examples of major file formats that can handle still images include, but are not limited to, JPG (Joint Photograph Experts Group), GIF (Graphics Interchange Format), BMP (Bitmap), and TIFF (Tagged Image File Format). Preferably, in the exemplified embodiment of the present invention, still image data can be provided in JPG format.

When a stereoscopically visible screen shot is stored, the CPU 311 can store the screen shot as an image (one file) including an image for a left eye and an image for a right eye that are arranged side by side. In addition, the CPU 311 may separately store the image for a left eye and the image for a right eye in different files, such that, when reproduced later, a synthesized image can be generated from a set of the images through the rectangle-shaped images described above to provide a stereoscopically visible image. Alternatively, the CPU 311 may store a stereoscopic viewing image by the following method. Specifically, the CPU 311 divides each of an image for a left eye and an image for a right eye into aligned rectangle-shaped images each having one line of pixels in the vertical direction. Next, the CPU 311 synthesizes an image in which the rectangle-shaped images of the divided image for a right eye and the rectangle-shaped images of the divided image for a left eye are alternately aligned, and provides the synthesized image as one file.

Here, the game apparatus 10 can capture a stereoscopic viewing image with a small processing load and a small information volume by storing data including an image for a left eye and an image for a right eye as still image data. In addition, from a series of sequentially displayed images representing an event in the virtual space, the player can store a part of the images that is generated on the basis of a desired disparity, as a stereoscopically visible image.

As described above, the game apparatus 10 can obtain an input operation that is performed by the user on the 3D adjustment switch 25 for adjusting the distance between the right virtual camera and the left virtual camera. Then, when selectively storing any of the sequentially outputted stereoscopically visible images (generating a screen shot), the game apparatus 10 reflects the above distance set by the input operation, in a rendering state of the virtual space represented by this image. Meanwhile, the game apparatus 10 can reproduce the screen shot stored thus, on the upper LCD 22 after the screen shot is stored.

However, when the screen shot is reproduced, even if an additional input is performed on the 3D adjustment switch 25, the game apparatus 10 reproduces the image for a left eye and the image for a right eye that are used for forming a stereoscopic viewing image, with the binocular disparity that is set when the screen shot is obtained (such that these images are the images taken with the inter-virtual camera distance that is set when the player performs a screen shot obtaining operation). This is because in the present embodiment, the 3D adjustment switch 25 is used for changing (adjusting) the inter-virtual camera distance and is not used for changing (adjusting) a deviation between the image for a right eye and the image for a left eye (hereinafter, referred to as an amount of deviation of still image data) that is provided when the stored stereoscopic viewing image is reproduced. In other words, this is because if the 3D adjustment switch 25 is used for changing the “disparity” of the reproduced stereoscopic viewing image, the amount of deviation of the still image data is changed, thereby providing a sense of perspective that is different from that when the inter-virtual camera distance is changed. Therefore, in the present embodiment, the 3D adjustment switch 25 is used for adjusting the inter-virtual camera distance, and is not used for changing the amount of deviation of the still image data.

Such a configuration can solve a problem involved when the stereoscopically visible image is reproduced. Conventionally, if an input value for the 3D adjustment switch 25 at reproduction is used for adjusting the “disparity” of a stereoscopic viewing image (screen shot) stored as a still image, a stereoscopic viewing image before obtaining the screen shot is different from a stereoscopic viewing image obtained when the disparity is adjusted (the inter-virtual camera distance is changed). Thus, unnatural stereoscopic viewing (sense of perspective) is provided to the player. However, according to the above configuration, the game apparatus 10 can stably provide a stereoscopically visible image that the player desires to store and that keeps desired disparity information.

As described above, the game apparatus 10 sequentially outputs images corresponding to an event occurring in the virtual space. The game apparatus 10 provides a predetermined reference point that moves or changes in direction in the virtual space, and sets the positions/orientations of the right virtual camera and the left virtual camera in accordance with the position and/or the direction of the reference point. Specifically, in the example of the virtual space shown in FIG. 4A, the virtual object OBJ1 serves as the reference point. In other words, the virtual object OBJ1 is a player object, and changes in position and/or direction (e.g., moves in the direction indicated by the arrow D1 in FIG. 4A) in accordance with an input operation performed by the player on the game apparatus 10 and a progress of the game processing. Alternatively, the reference point may be an indicator (e.g., a cursor) other than the player object, and may move or change in direction in the virtual space by the player directly controlling the reference point. Still alternatively, the reference point may move or change in direction automatically in accordance with a predetermined condition without an input operation of the player. For example, the reference point may move to a predetermined position or change in direction to a predetermined direction in accordance with a scene of the game, or may randomly move or change in direction.

Such a configuration allows the player of the game apparatus 10 to store any image from stereoscopic viewing images that change in accordance with movement of the reference point, thereby enhancing fun of collecting stereoscopic viewing images. When the reference point is the player object, in particular, the player can freely change the imaging range of the virtual camera. Thus, a desired stereoscopic viewing image can be stored, and fun of collecting stereoscopic viewing images can be enhanced further.

Further, as described above, when representing the virtual space, the game apparatus 10 can change the setting of the perspective transformation process between the first person viewpoint and the third person viewpoint. When progressing the game processing such that an operation for taking a screen shot is associated with the setting of the first person viewpoint, the game apparatus 10 can perform representation as if the player takes an image obtained when the virtual space is looked at from the viewpoint of the virtual object controlled by the player, thereby enhancing fun and realistic feeling.

Moreover, the viewpoint is set to the first person viewpoint at such a time of imaging, and is set to the third person viewpoint at normal time other than the time of imaging. When the game apparatus 10 has such a setting that the viewpoint is set to the first person viewpoint at a time of imaging and to the third person viewpoint at normal time, the player object is easily viewed and controlled at normal time by locating the left and right virtual cameras in a position other than the viewpoint of the player object. In addition, when a stereoscopic viewing image is stored, a stereoscopic viewing image that provides realistic feeling as if the player views the virtual space from the viewpoint of the player object can be stored by locating the left and right virtual cameras in a position corresponding to the viewpoint of the player object.

(Memory Map)

Here, main data that is stored in the main memory 32 while the game program is executed will be described. FIG. 5 is a schematic diagram showing a memory map of the main memory 32 of the game apparatus 10. As shown in. FIG. 5, the image processing program 70, the game program 71, virtual object information 72, screen shot information 73, various variables 74, and the like are stored in the main memory 32.

The image processing program 70 is called while the game processing based on the game program 71 is performed, or functions as a part of the game program 71, thereby performing processing of the exemplified embodiment of the present invention.

The game program 71 is a program for causing the information processing section 31 to execute a game display process.

The virtual object information 72 is information on virtual objects, and includes model information indicating shapes and patterns of virtual objects (e.g., information on polygons), and information on the current positions of virtual objects in a virtual space, and the like.

The screen shot information 73 is still image data corresponding to a screen shot that the game apparatus 10 obtains from sequentially outputted stereoscopically visible images by an input operation of the user.

The various variables 74 are used when the image processing program 70 and the game program 71 are executed.

(Flow of Exemplified Processing)

Hereinafter, a flow of processing performed on the basis of the image processing program of the exemplified embodiment of the present invention will be described with reference to flowcharts in FIG. 6A and the subsequent drawings. In FIG. 6A and the subsequent drawings, “step” is abbreviated to “S”. Note that the flowcharts in FIG. 6A and the subsequent drawings are merely examples of a processing procedure. Therefore, the order of each process step may be changed as long as the same result is obtained. In addition, the values of the variables and thresholds used at determination steps are also merely examples, and other values may be used as necessary.

FIG. 6A is a flowchart showing an example of main processing performed on the basis of the image processing program 70 in the game apparatus 10 that is the exemplified embodiment of the present invention.

At step 101, the CPU 311 locates virtual objects in a virtual space. Specifically, in the case of the example shown in FIG. 4A, coordinates (world coordinates) of the positions of the virtual object OBJ1 and the virtual object OBJ2 in the virtual space are provided in accordance with a content stored in the main memory 32. The CPU 311 locates the three-dimensional model defined for the virtual objects OBJ1 and OBJ2, respectively, in accordance with the positions (P1 and P2) of the virtual objects OBJ1 and OBJ2 in the virtual space.

At step 102, the CPU 311 obtains a distance (inter-virtual camera distance) between the right virtual camera and the left virtual camera which distance is calculated in accordance with the position of the 3D adjustment switch 25.

At step 103, the CPU 311 sets and updates the positions of the two virtual cameras (the right virtual camera and the left virtual camera) in the virtual space in accordance with the inter-virtual camera distance obtained at step 102.

At step 104, the CPU 311 takes an image of the virtual space with the two virtual cameras (the right virtual camera and the left virtual camera) set at step 102, renders the obtained stereoscopic viewing image (an image for a right eye and an image for a left eye), and displays these images on the upper LCD 22. Specifically, the CPU 311 processes the image for a right eye and the image for a left eye as follows. The CPU 311 divides each of the image for a right eye and the image for a left eye into aligned rectangle-shaped images each having one line of pixels in the vertical direction, and synthesizes an image in which the rectangle-shaped images of the divided image for a right eye and the rectangle-shaped images of the divided image for a left eye are alternately arranged, and displays the synthesized image on the screen of the upper LCD 22.

At step 105, the CPU 311 determines whether or not an internal state in the game processing has shifted to a readiness state for taking a screen shot (a screen shot taking standby state).

Specifically, when having received a signal indicating that the R button 14H of the game apparatus 10 has been pressed, the CPU 311 determines that the internal state in the game processing is in the screen shot taking standby state (Yes at step 105), and proceeds to a process at the next step 106. On the other hand, when not having detected the signal indicating that the R button 14H of the game apparatus 10 has been pressed, the CPU 311 determines that the internal state in the game processing is not in the screen shot taking standby state (No at step 105), skips the process at step 106, and proceeds to a process at step 107.

At step 106, the CPU 311 performs a screen shot taking process. Specifically, a series of processes are performed as shown in FIG. 6B. The screen shot taking process (from step 201 to step 209) will be described in detail with reference to FIG. 6B.

FIG. 6B is a flowchart showing an example of the screen shot taking process in the flowchart of FIG. 6A.

At step 201, the CPU 311 moves the position of the virtual camera to a position (first person viewpoint) corresponding to the viewpoint of the player object. Then, the CPU 311 proceeds to a process at step 202.

At step 202, the CPU 311 renders and displays a stereoscopic viewing image obtained by taking an image of the virtual space with the virtual camera.

The series of steps 201 and 202 will be described, for example, with virtual objects and a virtual space that have a positional relation as shown in FIG. 4A. First, the CPU 311 sets the viewpoint of the virtual object OBJ1, which is the player object, to the position (viewpoint) of the virtual camera (step 201), and performs the perspective transformation process on the basis of the viewpoint (with the arrow D2 as a line-of-sight direction). As a result, for example, as shown in FIG. 4B, the CPU 311 displays an image viewed from the viewpoint of the virtual object OBJ1 and corresponding to the virtual object OBJ2, on the upper LCD 22 such that the image is stereoscopically visible (step 202). After the process at step 202, the CPU 311 proceeds to a process at step 203.

At step 203, the CPU 311 determines whether or not a signal corresponding to an operation for instructing to take a screen shot has been obtained. Specifically, when having received a signal indicating that pressing of the R button 14H of the game apparatus 10 has been released (Yes at step 203), the CPU 311 proceeds to a process at step 204. On the other hand, when the CPU 311 has not detected the signal, namely, when the R button 14H of the game apparatus 10 is continuously pressed (No at step 203), the CPU 311 proceeds to a process at step 206.

At step 204, the CPU 311 takes a screen shot, and performs predetermined presentation indicating that the screen shot has been taken, to the user. Specifically, the CPU 311 takes a screen shot, and at the same time, the CPU 311 reproduces audio data (e.g., data including a sound such a shutter sound of a camera, which provides an impression that the operation of the user is reflected.

At step 205, the CPU 311 stores the screen shot image taken at step 204, in the work area of the main memory 32 of the game apparatus 10.

At step 206, the CPU 311 determines whether or not an imaging cancellation operation has been performed. Specifically, when having detected a signal indicating that the L button 14G of the game apparatus 10 has been pressed (Yes at step 206), the CPU 311 ends this subroutine, and proceeds to the process at step 107 (FIG. 6A). On the other hand, when not having detected the signal (No at step 206), the CPU 311 proceeds to a process at step 207.

At step 207, the CPU 311 determines whether or not an operation has been performed on the 3D adjustment switch 25. Specifically, when having detected a signal indicating that the slider 25a of the 3D adjustment switch 25 of the game apparatus 10 has been moved (Yes at step 207), the CPU 311 proceeds to a process at step 208. On the other hand, when not having detected the signal (No at step 207), the CPU 311 returns to the process at step 202.

At step 208, the CPU 311 obtains a distance (inter-virtual camera distance) between the right virtual camera and the left virtual camera which distance is calculated in accordance with the position of the slider 25a of the 3D adjustment switch 25.

At step 209, the CPU 311 sets and updates the positions of the two virtual cameras (the right virtual camera and the left virtual camera) in the virtual space in accordance with the inter-virtual camera distance obtained at step 208. Then, the CPU 311 returns to the process at step 202.

Referring back to FIG. 6A, a series of processes at steps 107 to 110 performed after the screen shot taking process at step 106 (corresponding to steps 201 to 209) is performed will be described.

At step 107, the CPU 311 determines whether or not to end the game processing. For example, when an input operation for ending the game processing has been performed by the player on the game apparatus 10 or the game progress satisfies a predetermined condition (e.g., a stage is cleared) (Yes at step 107), the CPU 311 proceeds to a process at step 108. On the other hand, when an input operation for not ending the game processing has been performed by the player on the game apparatus 10 or the game progress does not satisfy the predetermined condition (No at step 107), the CPU 311 returns to step 101 and repeats the processes at steps 101 to 106.

At step 108, the CPU 311 displays a list of taken screen shots. Specifically, the CPU 311 displays screen shot images stored in the work area of the main memory 32 at step 205, on a display area of the game apparatus 10 (e.g., the upper LCD 22). More specifically, in order to allow the player to confirm taken pictures, the game apparatus 10 can display screen shot images as still images obtained by copying an image for a left eye and an image for a right eye into a texture and compressing the texture, but the form of the display is not limited thereto.

At step 109, the CPU 311 prompts the player to perform a selection operation in the list displayed at step 108, and confirms with the player whether or not to store any of the images displayed in the list. When an input operation that is a selection operation indicating that any of the images is selected has been performed by the player on the game apparatus 10 (Yes at step 109), the CPU 311 proceeds to a process at 110. On the other hand, when an input operation indicating that it is not necessary to store any image has been performed by the player on the game apparatus 10 (No at step 109), the CPU 311 skips the process at step 110, and ends the main processing.

At step 110, the CPU 311 stores the image in any of nonvolatile storage areas (e.g., the internal data storage memory 35 and the external data storage memory 45) of the game apparatus 10 in accordance with the selection operation of the player in the list displayed at the step 108. Then, the CPU 311 ends the main processing.

(Additional Application)

The game apparatus 10 may has an application program for taking an image as described above and calling a group of stored screen shots. Such an application program will be described with reference to FIG. 6C.

Specifically, a processing procedure as shown in FIG. 6C may be shown. FIG. 6 is a flowchart showing an example of a taken image display process.

At step 301, the CPU 311 displays a list (thumbnail) of taken images (stereoscopic viewing still images stored by a screen shot obtaining operation performed by the user: screen shot images) present in the storage area of the game apparatus 10, in accordance with an input operation performed by the user for activating the application.

At step 302, the CPU 311 determines whether or not an operation of selecting an image from among the taken image group displayed in the list has been performed by the user. When determining that a signal corresponding to the operation of the selection has been generated (Yes at step 302), the CPU 311 proceeds to a process at step 303. On the other hand, when determining that there is no signal corresponding to the operation of the selection (No at step 302), the CPU 311 skips processes at steps 303 to 305, and proceeds to a process at step 306.

At step 303, the CPU 311 displays the stereoscopic viewing image selected by the user, on the upper LCD 22.

At step 304, the CPU 311 determines whether or not an input for requesting to change the display method of the displayed image has been performed by the player.

Specifically, when determining that there is the request to change the display method of the image (Yes at step 304), the CPU 311 proceeds to a process at step 305. On the other hand, when determining that there is no request to change the display method of the image (No at step 304), the CPU 311 proceeds to a process at step 306. Here, the change of the display method of the taken image is change of the form of the display of the image, and includes changes such as expansion/contraction of the image, edit of the image. When the change is permitted, the CPU 311 provides an icon indicating “changeable” to an image, in the above taken image list (see step 301), for which the change is permitted, and displays the icon. Thus, the CPU 311 shows the user that the display method is changeable. As a matter of course, when the change of the display method is not permitted for any of the taken images, the processes at steps 304 and 305 may not be performed. Note that the change of the display method may include operations providing additional information, such as addition of additional related information and addition of a frame image surrounding a screen shot.

At step 306, the CPU 311 determines whether or not to end the application. Specifically, when an input operation indicating a request to end the application has been performed by the player on the game apparatus 10 (Yes at step 306), the CPU 311 ends the processing of the application. On the other hand, when the input operation indicating a request to end the application has not been performed by the player on the game apparatus 10 (No at step 306), the CPU 311 returns to the process at step 302.

(Main Modifications)

In another embodiment, displaying and/or storing of a screen shot (a stereoscopically visible image) that are performed in the image processing apparatus of the present invention are not limited to those in the exemplified embodiment described above. For example, displaying and/or storing may be performed while the player makes the player object take an action in the virtual space.

In another embodiment, the condition for taking a stereoscopic viewing image as a screen shot is not limited to an operation of the player, and a stereoscopic viewing image may be taken as a screen shot in accordance with a condition corresponding to the progress of the game processing (e.g., when the progress of the game reaches a specific scene) or another parameter (e.g., an elapsed time from the start of the game).

In order to set a display state of a virtual object, which is an object of the screen shot described above and located in the virtual space, such that a stereoscopic viewing image can be generated later and its content can be changed, an image processing apparatus of another embodiment of the present invention may obtain a screen shot as follows. For example, when a screen shot is obtained, the screen shot may be stored, not as still image data, but in a form that allows a stereoscopic viewing image to be generated later and its content to be changed. Data in such a form can include a world coordinate of a virtual object, a local coordinate defined for the model for the virtual object, the position of a viewpoint (virtual camera) at perspective transformation, the distance between a plurality of virtual cameras for providing stereoscopic viewing. For the screen shot obtained thus, the inter-virtual camera distance can be changed by operating the 3D adjuster at reproduction. Thus, the disparity of even the reproduced stereoscopic viewing image can be adjusted.

(Other Respects)

In the exemplified embodiment describe above, the display device (upper LCD 22) that provides stereoscopic viewing with naked eyes is used, and the parallax barrier method is used as a method for providing stereoscopic viewing with naked eyes. However, in another embodiment, another method (e.g., a lenticular lens method) may be used. Alternatively, the image processing program and the like of the present invention may be applied to display of a display device using another method. For example, a method in which special eyeglasses are used (e.g., an anaglyph method, a polarization method, a time-sharing shutter method) may be used to provide stereoscopic viewing by using binocular disparity. For example, in the anaglyph method, an image for a left eye is rendered in blue, and an image for a right eye is rendered in red. Then, an observer can obtain a sense of perspective based on binocular disparity, by observing these images with a anaglyph scope (eyeglasses having a red filter for a left eye and a blue filter for a right eye).

In the exemplified embodiment described above, the image processing program 70 is used with the game apparatus 10. However, in another embodiment, the image processing program of the present invention may be used with any information processing apparatus or any information processing system (e.g., a PDA (Personal Digital Assistant), a mobile phone, a personal computer, or a camera).

In addition, in the exemplified embodiment described above, the image processing program is executed in game processing by using only one apparatus (game apparatus 10). However, in another embodiment, a plurality of information processing apparatuses, included in an image display system, that can communicate with each other may share the execution of the image processing program.

Note that in the case where the image processing program and the like of the present invention are used on a general-purpose platform, the image processing program may be provided under the condition that a standard program module provided on the platform is used. It should be understood that even if a function corresponding to such a module as described above is excluded from the image processing program, the resultant image processing program substantially corresponds to the original image processing program as long as the module complements the excluded function.

While the invention has been described in detail, the foregoing description is in all aspects illustrative and not restrictive. It is understood that numerous other modifications and variations can be devised without departing from the scope of the invention. It should be understood that the scope of the present invention is interpreted only by the scope of the claims. It is also understood that, from the description of specific embodiments of the present invention, the one skilled in the art can easily implement the present invention in the equivalent range based on the description of the present invention and on the common technological knowledge. Further, it should be understood that terms used in the present specification have meanings generally used in the art concerned unless otherwise specified. Therefore, unless otherwise defined, all the jargon and technical terms have the same meanings as those generally understood by one skilled in the art of the present invention. In the event of any conflict, the present specification (including meanings defined herein) has priority.

What is claimed is:

1. An image processing apparatus comprising:
virtual camera setting means for setting a left virtual camera and a right virtual camera such that the left virtual camera and the right virtual camera are spaced apart from each other at a predetermined interval for taking an image of a virtual space;
stereoscopic viewing image output means for sequentially outputting stereoscopic viewing images each of which is generated on the basis of an image for a left eye obtained by taking an image of the virtual space with the left virtual camera and an image for a right eye obtained by taking an image of the virtual space with the right virtual camera; and
stereoscopic viewing image storing means for storing any of the stereoscopic viewing images sequentially outputted by the stereoscopic viewing image output means, on the basis of a predetermined condition.

2. The image processing apparatus according to claim 1, wherein the stereoscopic viewing image storing means stores the stereoscopic viewing image as still image data including the image for the left eye and the image for a right eye.

3. The image processing apparatus according to claim 1, further comprising camera interval setting means for setting an interval between the left virtual camera and the right virtual camera on the basis of an input from a user, wherein
the camera interval setting means sets the left virtual camera and the right virtual camera on the basis of the interval set by the camera interval setting means,
the stereoscopic viewing image output means sequentially outputs stereoscopic viewing images on the basis of an image for a left eye and an image for a right eye that are obtained by taking images of the virtual space with the left virtual camera and the right virtual camera on the basis of the set interval, and
the stereoscopic viewing image storing means stores any of the output stereoscopic viewing images on the basis of a predetermined condition.

4. The image processing apparatus according to claim 1, further comprising reproduction means for reproducing later the stereoscopic viewing image stored in the stereoscopic viewing image storing means.

5. The image processing apparatus according to claim 2, further comprising reception means for receiving, from a user, an input for adjusting a disparity of the stereoscopic viewing image, wherein
the camera interval setting means sets the interval between the left virtual camera and the right virtual camera such that the interval corresponds to a disparity based on the input received by the reception means,
the stereoscopic viewing image storing means stores any of the outputted stereoscopic viewing images with the set disparity on the basis of a predetermined condition, and
when reproducing the stereoscopic viewing image stored as the still image data, the reproduction means reproduces an image for a left eye and an image for a right eye that are used for forming the stereoscopic viewing image, with the set disparity regardless of the input received by the reception means.

6. The image processing apparatus according to claim 1, wherein
a predetermined reference point that changes in position or direction in the virtual space is present in the virtual space, and
the left virtual camera and the right virtual camera can be set in accordance with the position and/or the direction of the reference point.

7. The image processing apparatus according to claim 6, wherein the reference point is a player object of which movement is controlled by an input of a user.

8. The image processing apparatus according to claim 1, further comprising input means for obtaining input information from a user, wherein
the predetermined condition is that predetermined input information is obtained by the input means, and
the stereoscopic viewing image storing means stores a stereoscopic viewing image that is outputted by the stereoscopic viewing image output means when the predetermined input information is obtained.

9. The image processing apparatus according to claim 1, wherein
a plurality of virtual objects including a player object that is controllable by a player is present in the virtual space, and
the virtual camera setting means sets the left virtual camera and the right virtual camera such that the left virtual camera and the right virtual camera are located in a position corresponding to a viewpoint of the player object.

10. The image processing apparatus according to claim 1, wherein
the virtual camera setting means sets the left virtual camera and the right virtual camera such that the left virtual camera and the right virtual camera are located in a position that is reversibly and selectively changed between a position corresponding to a viewpoint of the player object and a position other than the position corresponding to the viewpoint of the player object, and
the stereoscopic viewing image storing means stores a stereoscopic viewing image that is outputted by the stereoscopic viewing image output means after the left virtual camera and the right virtual camera are set by the virtual camera setting means so as to be located in the position corresponding to the viewpoint of the player object.

11. The image processing apparatus according to claim 1, wherein
a plurality of virtual objects including a player object that is controllable by a player is present in the virtual space,
the image processing apparatus further comprises display state determination means for determining a display state of the plurality of virtual objects on the basis of a predetermined parameter, and
the stereoscopic viewing image storing means stores the predetermined parameter and positions of the left virtual camera and the right virtual camera.

12. The image processing apparatus according to claim 4, wherein the reproduction means provides a predetermined image and predetermined information to the reproduced stereoscopic viewing image, and displays the predetermined image and the predetermined information.

13. The image processing apparatus according to claim 4, further comprising edit means for editing the reproduced stereoscopic viewing image on the basis of an operation of a user.

14. A computer-readable storage medium having stored therein an image processing program that is executed by a computer of an image processing apparatus capable of outputting a virtual space in a stereoscopically visible manner, the image processing program causing the computer to operate as:
virtual camera setting means for setting a left virtual camera and a right virtual camera such that the left virtual camera and the right virtual camera are spaced apart from each other at a predetermined interval for taking an image of a virtual space;
stereoscopic viewing image output means for sequentially outputting stereoscopic viewing images each of which is generated on the basis of an image for a left eye obtained by taking an image of the virtual space with the left virtual camera and an image for a right eye obtained by taking an image of the virtual space with the right virtual camera; and
stereoscopic viewing image storing means for storing any of the stereoscopic viewing images sequentially outputted by the stereoscopic viewing image output means, on the basis of a predetermined condition.

15. An image processing method for outputting a virtual space in a stereoscopically visible manner, the image processing method comprising:
a virtual camera setting step of setting a left virtual camera and a right virtual camera such that the left virtual camera and the right virtual camera are spaced apart from each other at a predetermined interval for taking an image of a virtual space;
a stereoscopic viewing image output step of sequentially outputting stereoscopic viewing images each of which is generated on the basis of an image for a left eye obtained by taking an image of the virtual space with the left virtual camera and an image for a right eye obtained by taking an image of the virtual space with the right virtual camera; and
a stereoscopic viewing image storing step of storing any of the stereoscopic viewing images sequentially outputted by the stereoscopic viewing image output step, on the basis of a predetermined condition.

16. An image processing system capable of outputting a virtual space in a stereoscopically visible manner, the image processing system comprising:
virtual camera setting means for setting a left virtual camera and a right virtual camera such that the left virtual camera and the right virtual camera are spaced apart from each other at a predetermined interval for taking an image of a virtual space;
stereoscopic viewing image output means for sequentially outputting stereoscopic viewing images each of which is generated on the basis of an image for a left eye obtained by taking an image of the virtual space with the left virtual camera and an image for a right eye obtained by taking an image of the virtual space with the right virtual camera; and
stereoscopic viewing image storing means for storing any of the stereoscopic viewing images sequentially outputted by the stereoscopic viewing image output means, on the basis of a predetermined condition.
